(19) United States
(12) Patent Application Publication
(10) Pub. No.: US 2023/0299535 A1
(43) Pub. Date: Sep. 21, 2023

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroki KOBAYASHI, Mie (JP); Hajime MATSUI, Mie (JP)

(21) Appl. No.: 18/007,897

(22) PCT Filed: May 18, 2021
(86) PCT No.: PCT/JP2021/018714

§ 371 Date: Dec. 2, 2022

(30) Foreign Application Priority Data
Jun. 8, 2020 (JP) 2020-099367

(51) Int. Cl. H01R 13/514; H01R 13/432; H01R 13/58

(52) U.S. Cl. CPC H01R 13/514; H01R 13/432; H01R 13/5833

(57) ABSTRACT

A connector 10 of the present disclosure is provided with a plurality of terminals 30, a plurality of wires 20, a plurality of sub-housings 60, 70 and a lock member 80. The terminal 30 includes a locked portion. The sub-housings 60, 70 include cavities 61, 71 for accommodating the terminals 30 and locking portions for retaining the terminals 30 by locking the locked portions from behind. The plurality of wires 20 are respectively pulled out rearward from the plurality of terminals 30. The plurality of sub-housings 60, 70 are assembled with each other with the locked portions of the terminals 30 facing in the same direction, and held in an assembled state by the lock member 80.

### TECHNICAL FIELD

The present disclosure relates to a connector.

### BACKGROUND

Conventionally, a connector described in Japanese Patent Laid-open Publication No. 2019-067562 (Patent Document 1 below) is known as a connector in which a plurality of sub-housings capable of accommodating terminals are stacked in a vertical direction. The plurality of sub-housings include the uppermost stage sub-housing arranged in the uppermost stage, the middle stage sub-housing disposed to face the uppermost stage sub-housing and the lowermost stage sub-housing disposed in the lowermost stage. The uppermost stage sub-housing includes a retaining portion for retaining the terminals accommodated inside the middle stage sub-housing, and the middle stage sub-housing includes at least a pair of retaining portions for retaining the terminals accommodated inside the uppermost stage sub-housing and the terminals accommodated inside the lowermost stage sub-housing. On the other hand, the terminal includes a locked portion to be locked by the retaining portion.

### PRIOR ART DOCUMENT

### Patent Document

Patent Document 1: JP 2019-067562 A

### SUMMARY OF THE INVENTION

### Problems to be Solved

In the above connector, the terminals are accommodated into the lowermost stage and middle stage sub-housings with the locked portions facing up, and the terminals are accommodated into the uppermost stage sub-housing with the locked portions facing down. Specifically, after the terminals are accommodated into the uppermost stage sub-housing with the lower surface of the uppermost stage sub-housing facing up, this uppermost stage sub-housing needs to be turned upside down and then assembled with the middle stage sub-housing from above. A turn-over operation is necessary extra only when the uppermost stage sub-housing is assembled as just described, and an assembling operation of the sub-housings becomes cumbersome.

The technique disclosed in this specification was completed on the basis of the above situation and aims to provide a connector capable of simplifying an assembling operation of sub-housings.

### Means to Solve the Problem

The present disclosure is directed to a connector with a plurality of terminals, a plurality of wires, a plurality of sub-housings and a lock member, the terminal including a locked portion, the sub-housing including a terminal accommodating portion for accommodating the terminal and a locking portion for retaining the terminal by locking the locked portion from behind, the plurality of wires being respectively pulled out rearward from the plurality of terminals, and the plurality of sub-housings being assembled with each other with the locked portions of the terminals facing in the same direction, the plurality of sub-housings being held in an assembled state by the lock member.

### Effect of the Invention

According to the present disclosure, an assembling operation of sub-housings can be simplified.

### BRIEF DESCRIPTION OF THE DRAWINGS

FIG. 1 is a perspective view of a connector viewed obliquely from above.

FIG. 2 is a front view of the connector.

FIG. 3 is a section along A-A of FIG. 2.

FIG. 4 is a side view of the connector.

FIG. 5 is a section along B-B of FIG. 4.

FIG. 6 is a section along C-C of FIG. 4.

FIG. 7 is a section along D-D of FIG. 4.

FIG. 8 is a section along E-E of FIG. 4.

FIG. 9 is an exploded perspective view of housings viewed obliquely from above.

FIG. 10 is an exploded perspective view of the housings viewed obliquely from below.

FIG. 11 is a section showing an internal structure of a terminal.

FIG. 12 is a perspective view showing an assembling step 1 of the connector.

FIG. 13 is a perspective view showing an assembling step 2 of the connector.

FIG. 14 is a perspective view showing an assembling step 3 of the connector.

FIG. 15 is a perspective view showing an assembling step 4 of the connector.

FIG. 16 is a perspective view showing an assembling step 5 of the connector.

FIG. 17 is a perspective view showing an assembling step 6 of the connector.

### DETAILED DESCRIPTION TO EXECUTE THE INVENTION

### Description of Embodiments of Present Disclosure

First, embodiments of the present disclosure are listed and described.
(1) The connector of the present disclosure is provided with a plurality of terminals, a plurality of wires, a plurality of sub-housings and a lock member, the terminal including a locked portion, the sub-housing including a terminal accommodating portion for accommodating the terminal and a locking portion for retaining the terminal by locking the locked portion from behind, the plurality of wires being respectively pulled out rearward from the plurality of terminals, and the plurality of sub-housings being assembled with each other with the locked portions of the terminals facing in the same direction, the plurality of sub-housings being held in an assembled state by the lock member.

Since the plurality of sub-housings can be assembled with each other with the locked portions of the terminals facing in the same direction, the sub-housings need not be turned upside down after the terminals are accommodated into the sub-housings and an assembling operation of the sub-housings can be simplified.
(2) Preferably, the sub-housing includes a wire bending portion for bending the wire in a direction different from a pull-out direction of the wire and a side surface disposed laterally to the wire bending portion, the lock member includes a collective locking portion for collectively holding the plurality of sub-housings in the assembled state, and the collective locking portion is arranged to face parts of the side surfaces corresponding to the wire bending portions.

Since the wires bent by the wire bending portions try to be restored to initial shapes by reaction forces, the wires act to separate the respective sub-housings. Accordingly, the collective locking portion is arranged to face the parts of the side surfaces of the sub-housings corresponding to the wire bending portions. Therefore, the separation of the respective sub-housings can be effectively suppressed.
(3) Preferably, the wire bending portion includes a plurality of individual bending portions for individually bending and holding a plurality of the wires.

Since the wires are individually bent and held by the individual bending portions, there is no interaction between the wires and holding forces do not change due to an increase or decrease in the number of the wires.

### Details of Embodiment of Present Disclosure

### Embodiment

A specific example of a connector 10 of the present disclosure is described below with reference to the drawings. Note that the present invention is not limited to these illustrations and is intended to be represented by claims and include all changes in the scope of claims and in the meaning and scope of equivalents.

[Connector 10]

The connector 10 is provided with a plurality of terminals 30, a plurality of wires 20, a plurality of sub-housings 60, 70 and a lock member 80. The plurality of sub-housings 60, 70 are made of synthetic resin and include a first sub-housing 60 disposed in the lowermost stage and a pair of second sub-housings 70 stacked on a side above the first sub-housing 60.

[Wires 20]

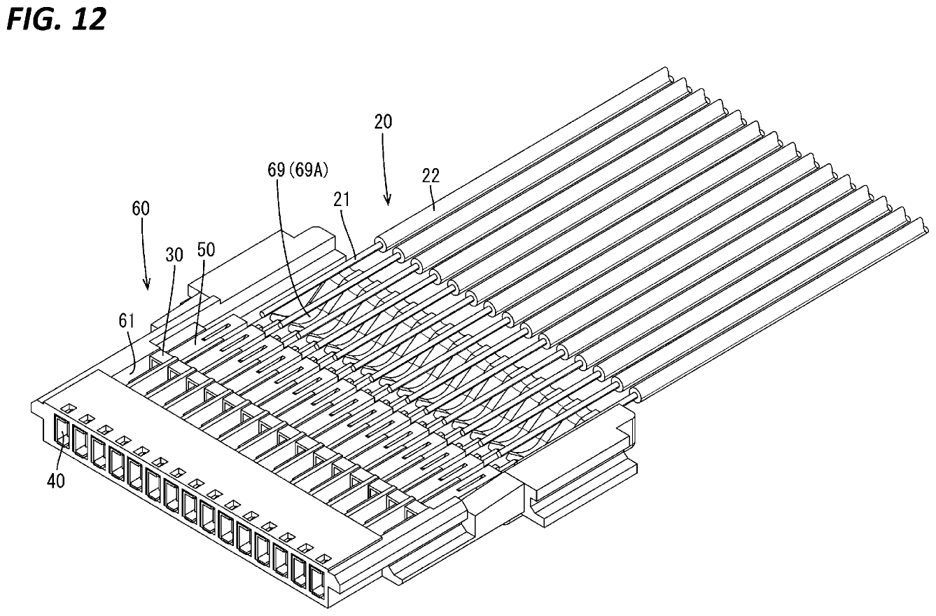

As shown in FIG. 12, the wires 20 are disposed to extend in a front-rear direction. The wire 20 includes a core wire 21 and an insulation coating 22 surrounding the outer periphery of the core wire 21. The insulation coating 22 is made of insulating synthetic resin. Although the core wire 21 of this embodiment is a single core wire constituted by one metal wire, the core wire 21 may be a stranded wire formed by standing a plurality of thin metal wires. Although the core wire 21 of this embodiment is made of copper or copper alloy, an arbitrary metal such as copper, copper alloy, aluminum or aluminum alloy can be appropriately selected as a metal constituting the core wire 21 if necessary.

[Terminal 30]

The terminal 30 includes a terminal body 40 made of metal and a slide portion 50 slidable with respect to the terminal body 40.

[Terminal Body 40]

The terminal body 40 is formed into a predetermined shape by a known method such as press-working, cutting or forging. An arbitrary metal such as copper, copper alloy, aluminum, aluminum alloy or stainless steel can be appropriately selected as a metal constituting the terminal body 40 if necessary. The terminal body 40 of this embodiment is made of copper or copper alloy. A plating layer may be formed on the surface of the terminal body 40. An arbitrary metal such as tin, nickel or silver can be appropriately selected as a metal constituting the plating layer if necessary. Tin plating is applied to the terminal body 40 of this embodiment.

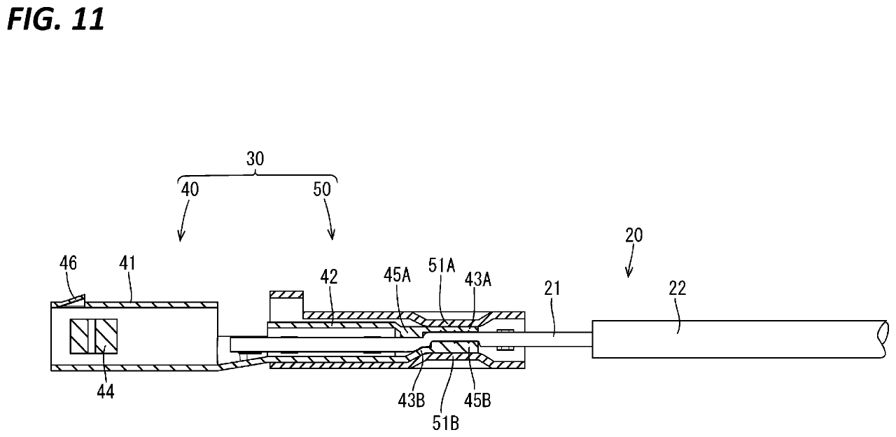

As shown in FIG. 11, the terminal body 40 includes a tube portion 41 and a wire connecting portion 42. A tab of an unillustrated mating terminal is insertable into the tube portion 41. The wire connecting portion 42 is located behind the tube portion 41. The wire connecting portion 42 is connected to the wire 20. The wire connecting portion 42 includes an upper sandwiching portion 43A and a lower sandwiching portion 43B.

The tube portion 41 is in the form of a rectangular tube extending in the front-rear direction. The front end of the tube portion 41 is open so that the tab is insertable thereinto. A contact piece 44 is disposed inside the tube portion 41. The contact piece 44 is resiliently deformable. The tab inserted into the tube portion 44 presses and resiliently deforms the contact piece 44. The tab is sandwiched between the inner wall of the tube portion 41 and the contact piece 44 by a resilient force of the resiliently deformed contact piece 44. In this way, the tab and the terminal 30 are electrically connected.

The wire connecting portion 42 in the form of a rectangular tube is provided behind the tube portion 41. The upper sandwiching portion 43A is provided to extend rearward in a rear end part of the ceiling wall (upper wall) of the wire connecting portion 42. The lower sandwiching portion 43B is provided to extend rearward in a front end part of the bottom wall (lower wall) of the wire connecting portion 42. The upper and lower sandwiching portions 43A, 43B have an elongated shape extending in the front-rear direction. The upper and lower sandwiching portions 43A, 43B are formed to have the same length in the front-rear direction. The same does not mean the same in a strict sense, but means to be in such a range regarded as the same that effects of the present disclosure are achieved.

An upper holding protrusion 45A is provided on the lower surface of the upper sandwiching portion 43A. The upper holding protrusion 45A is located forward of a rear end part of the upper sandwiching portion 43A. A lower holding protrusion 45B is provided on the upper surface of the lower sandwiching portion 43B. The lower holding protrusion 45B is disposed in a rear end part of the lower sandwiching portion 43B. The upper and lower holding protrusions 45A, 45B are provided at positions shifted in the front-rear direction.

The lower surface of the upper sandwiching portion 43A and the upper surface of the lower sandwiching portion 43B bite into an oxide film formed on the surface of the core wire 21 and strips the oxide film, thereby exposing a metal surface of the core wire 21. By the contact of the upper and lower sandwiching portions 43A, 43B with this metal surface, the core wire 21 and the terminal body 40 are electrically connected.

A locking lance 46 is provided in a front end of the ceiling wall (upper wall) of the tube portion 41. The locking lance 46 is cantilevered rearward. A rear end part of the locking lance 46 is resiliently displaceable in a vertical direction.

[Slide Portion 50]

The slide portion 50 is in the form of a rectangular tube extending in the front-rear direction. The slide portion 50 is formed by a known method such as press-working, cutting or forging if necessary. An arbitrary metal such as copper, copper alloy, aluminum, aluminum alloy or stainless steel can be appropriately selected as a metal constituting the slide portion 50 if necessary. The slide portion 50 of this embodiment is made of stainless steel, although not particularly limited. A plating layer may be formed on the surface of the slide portion 50. An arbitrary metal such as tin, nickel or silver can be appropriately selected as a metal constituting the plating layer if necessary.

The slide portion 50 is formed to have a cross-sectional shape, which is the same as or somewhat larger than a cross-sectional shape of a region of the terminal body 40 where the upper and lower sandwiching portions 43A, 43B are provided. In this way, the slide portion 50 is disposed outside the region of the terminal body 40 where the upper and lower sandwiching portions 43A, 43B are provided.

An upper pressurizing portion 51A projecting downward is provided on the lower surface of the ceiling wall (upper wall) of the slide portion 50. A lower pressurizing portion 51B projecting upward is provided on the upper surface of the bottom wall (lower wall) of the slide portion 50.

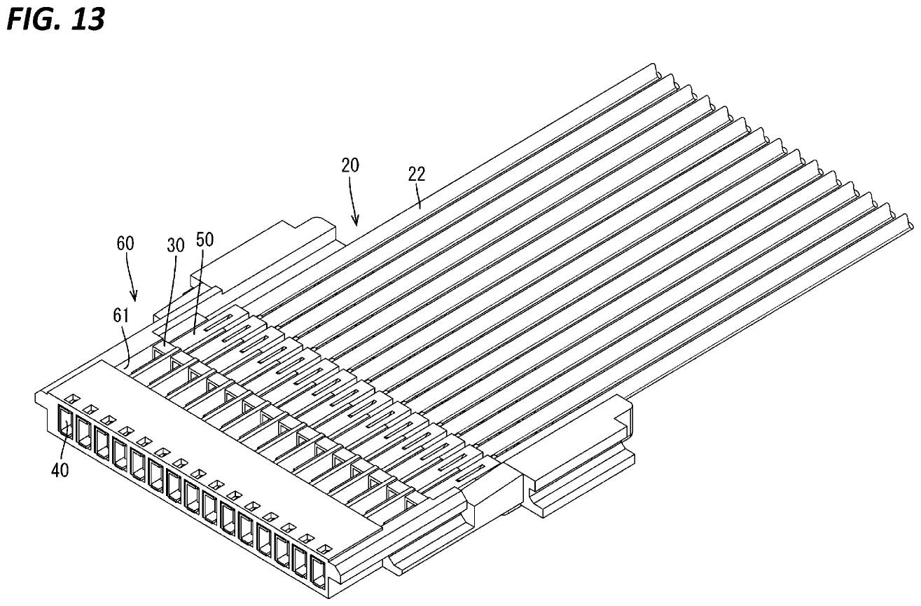

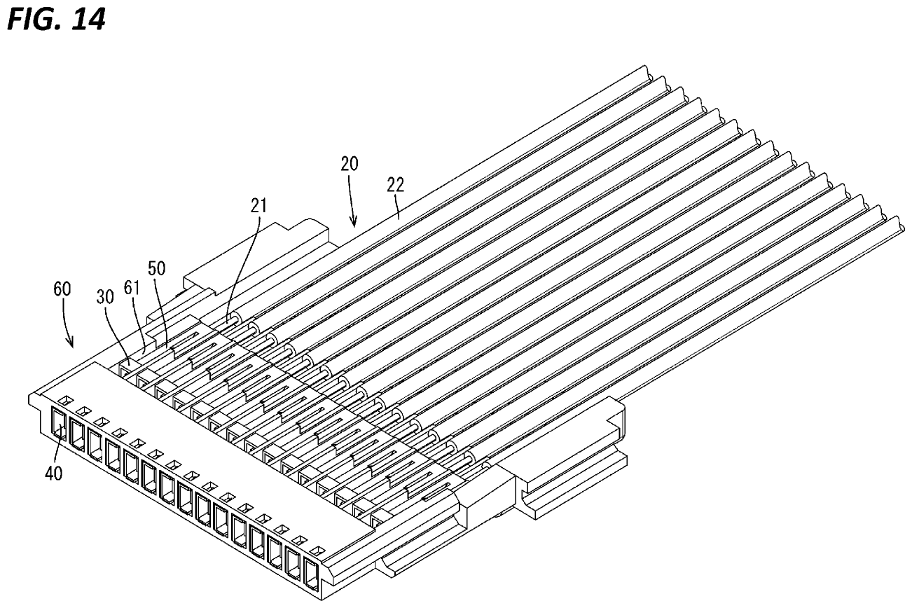

The slide portion 50 is slidable in the front-rear direction between a partial locking position shown in FIG. 13 and a full locking position shown in FIG. 14 while being externally fit to the region of the terminal body 40 where the upper and lower sandwiching portions 43A, 43B are provided.

With the slide portion 50 held at the full locking position with respect to the terminal body 40, the upper pressurizing portion 51A presses the upper surface of the upper sandwiching portion 43A from above, whereby the upper sandwiching portion 43A is displaced downward. Further, the lower pressurizing portion 51B presses the lower surface of the lower sandwiching portion 43B from below, whereby the lower sandwiching portion 43B is displaced upward.

In this way, with the core wire 21 disposed between the upper and lower sandwiching portions 43A, 43B and the slide portion 50 held at the full locking position with respect to the terminal body 40, the core wire 21 is vertically sandwiched by the upper and lower sandwiching portions 43A, 43B. That is, the upper sandwiching portion 43A resiliently contacts the core wire 21 from above by being pressed downward by the upper pressurizing portion 51A, and the lower sandwiching portion 43B resiliently contacts the core wire 21 from below by being pressed upward by the lower pressurizing portion 51B.

With the slide portion 50 held at the full locking position with respect to the terminal body 40, the upper holding protrusion 45A of the upper sandwiching portion 43A presses the core wire 21 from above and the lower holding protrusion 45B of the lower sandwiching portion 43B presses the core wire 21 from below. As a result, the core wire 21 is pressed from above by the upper holding protrusion 45A and pressed from below by the lower holding protrusion 45B disposed at a position shifted from the upper holding protrusion 45A in the front-rear direction, thereby being held in a state vertically bent in a stepped manner. Therefore, the core wire 21 and the terminal 30 are electrically connected also by the upper and lower holding protrusions 45A, 45B in addition to the upper and lower sandwiching portions 43A, 43B.

[First Sub-Housing 60]

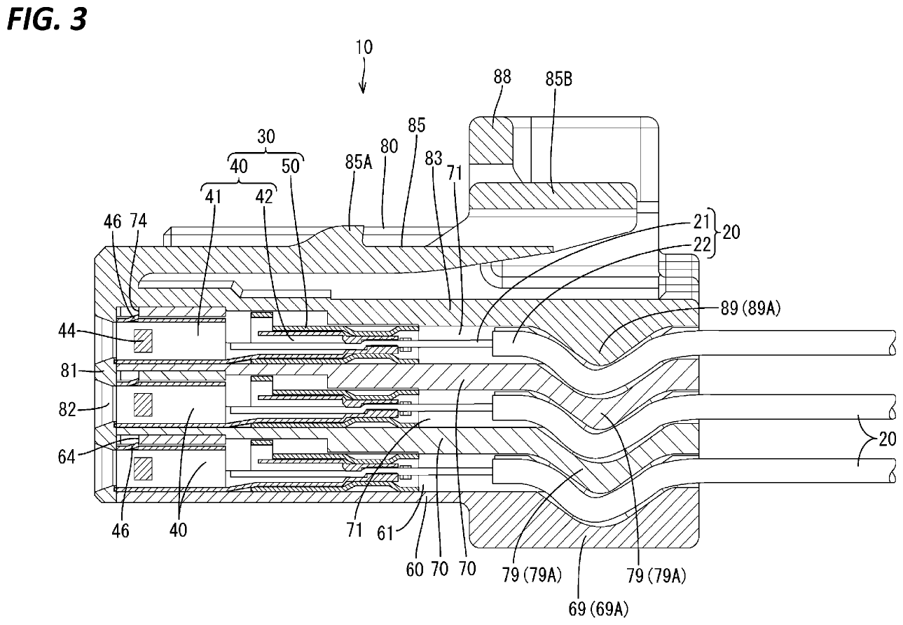

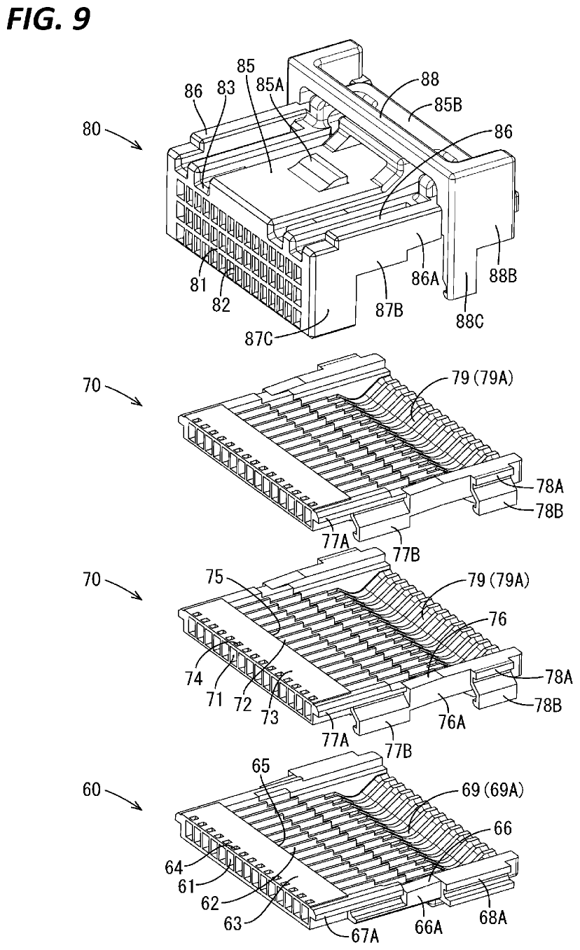

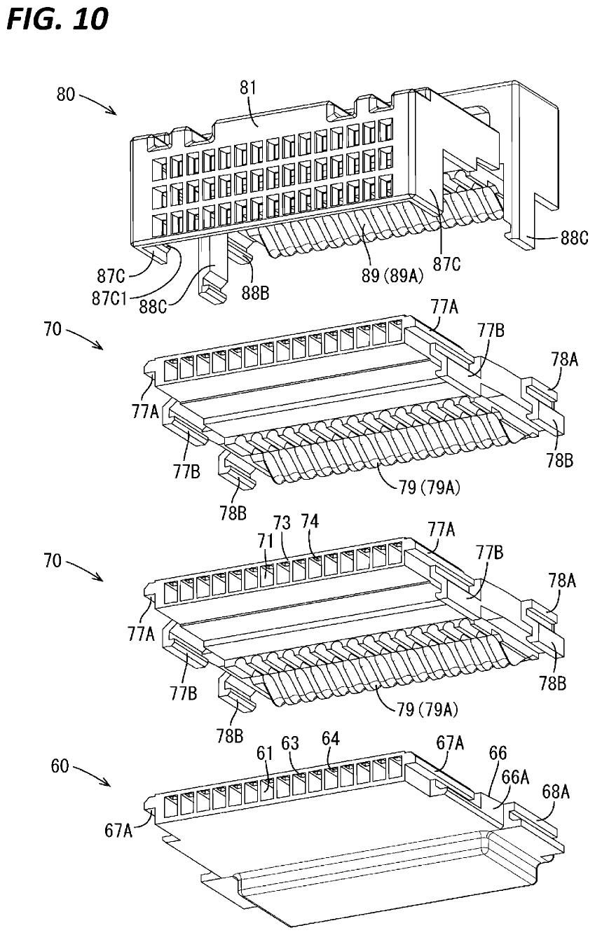

As shown in FIGS. 9 and 10, the first sub-housing 60 has a flat rectangular parallelepiped shape. Each sub-housing 60 includes a plurality of cavities 61 penetrating in the front-rear direction and arranged side by side in a width direction and a plurality of separation walls 62 disposed between the respective cavities 61. The respective cavities 61 are disposed to be vertically aligned with respective cavities 71 of the second sub-housing 70 when the respective sub-housings 60, 70 are properly stacked. The terminal 30 is insertable into each cavity 61 from behind. As shown in FIG. 3, a lance locking portion 64, to which the locking lance 46 is lockable from front, is provided on a front end side of a ceiling wall (upper wall) 63 of each cavity 61. The lance locking portion 64 is formed by providing a through hole vertically penetrating through the ceiling wall 63 of the cavity 61.

The ceiling wall 63 provided with the lance locking portion 64 is formed only in a front end part of the cavity 61, and a ceiling opening 65 is provided on a rear side of the ceiling wall 63. The cavity 61 is open upward in the ceiling opening 65. The ceiling opening 65 is closed by the lower surface of the second sub-housing 70 when the respective sub-housings 60, 70 are properly stacked.

As shown in FIG. 9, a front receiving portion 67A and a rear receiving portion 68A are provided on a side wall 66 of the first sub-housing 60. The front receiving portion 67A is provided to project in the width direction laterally inward of a side surface 66A of the side wall 66, and the rear receiving portion 68A is provided to project in the width direction laterally outward of the side surface 66A of the side wall 66.

As shown in FIG. 3, the terminal 30 is accommodated in a front half of the cavity 61, whereas the wire 20 is accommodated in a rear half of the cavity 61. The rear half of the cavity 61 is provided with an individual bending portion 69A in which the insulation coating 22 of the wire 20 is held while being bent downward. The upper surface of the individual bending portion 69A is recessed downward, whereas the lower surface thereof is flat. A plurality of the individual bending portions 69A are provided side by side in the width direction, and a wire bending portion 69 is constituted by the plurality of individual bending portions 69A.

[Second Sub-Housing 70]

As shown in FIGS. 9 and 10, the second sub-housings 70 have a flat rectangular parallelepiped shape. Each sub-housing 70 includes a plurality of cavities 71 penetrating in the front-rear direction and arranged side by side in the width direction and a plurality of separation walls 72 disposed between the respective cavities 71. Components common to the first sub-housing 60 are not described and are denoted by references signs obtained by changing tens places of the reference signs from 6 to 7.

In addition to a front receiving portion 77A and a rear receiving portion 78A, a front locking portion 77B and a rear locking portion 78B are provided on a side wall 76 of the second sub-housing 70. The front locking portion 77B is provided to project in the width direction laterally inward of a side surface 76A of the side wall 76, and the rear locking portion 78B is provided to project in the width direction laterally outward of the side surface 76A of the side wall 76. The side surface of the front locking portion 77B is disposed to be flush with the side surface 76A of the side wall 76.

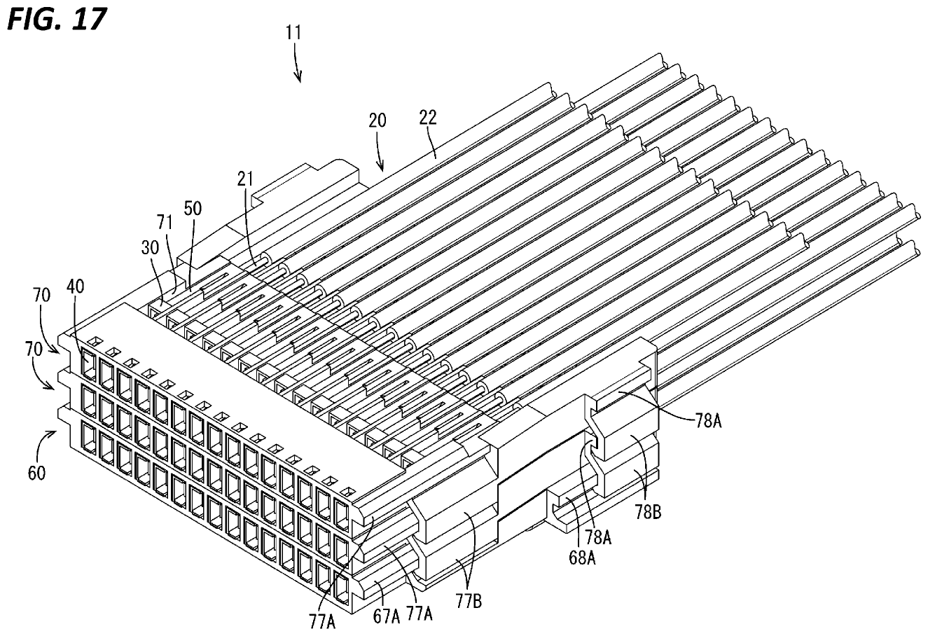

The front locking portion 77B locks the front receiving portion 67A of the first sub-housing 60 from below, and the rear locking portion 78B locks the rear receiving portion 78A of the first sub-housing 60 from below. In this way, the first sub-housing 60 and the second sub-housing 70 stacked above the first sub-housing 60 are held in a properly stacked state. Further, the second sub-housing 70 in an upper stage is assembled with the second sub-housing 70 in a lower stage, whereby a sub-housing assy 11 shown in FIG. 17 is configured.

The upper surface of the individual bending portion 79A is recessed downward, whereas the lower surface thereof projects downward. As shown in FIG. 3, the lower surface of the individual bending portion 79A is arranged in parallel to the upper surface of the individual bending portion 69A of the first sub-housing 60. In this way, the insulation coating 22 of the wire 20 in the lowermost stage is accommodated between the individual bending portion 69A of the first sub-housing 60 and the individual bending portion 79A of the second sub-housing 70. If the wire 20 is pulled rearward, the insulation coating 22 contacts the individual bending portions 69A, 79A to generate frictional resistance, whereby the insulation coating 22 of the wire 20 is held. In this way, the core wire 21 can be prevented from being pulled rearward when the wire 20 is pulled.

The insulation coating 22 of the wire 20 in the middle stage is accommodated between the individual bending portion 79A of the second sub-housing 70 in the lower stage and the individual bending portion 79A of the second sub-housing 70 in the upper stage. If the wire 20 is pulled rearward, the insulation coating 22 contacts a pair of the individual bending portions 79A to generate frictional resistance, whereby the insulation coating 22 of the wire 20 is held. In this way, the core wire 21 can be prevented from being pulled rearward when the wire 20 is pulled.

Each wire 20 is individually bent and held by each individual bending portion 69A, 79A. Thus, even if the number of the wires 20 increases or decreases, holding forces for the wires 20 do not change and can be kept constant regardless of the number of the wires 20.

Note that although tiny clearances are set between the individual bending portions 69A, 79A and the insulation coating 22 of the wire 20 in this embodiment, the insulation coating 22 of the wire 20 may be sandwiched and held by a pair of upper and lower individual bending portions 69A, 79A by eliminating the clearances.

[Lock Member 80]

The lock member 80 is made of synthetic resin and includes, as shown in FIGS. 9 and 10, a front member 81, a ceiling wall 83 and a pair of side walls 83. The front member 81 is provided with a plurality of cavities 82. As shown in FIG. 3, the respective cavities 82 are disposed side by side to communicate with the respective cavities 61, 71 of the respective sub-housings 60, 70 in the front-rear direction when the respective sub-housings 60, 70 and the ceiling wall 83 of the lock member 80 are properly stacked. The terminals 30 inserted into the respective cavities 61, 71 from behind are stopped in front by the front member 81.

As shown in FIG. 9, a lock arm 85 is provided on the upper surface of the ceiling wall 83. The lock arm 85 is cantilevered rearward from the front edge of the ceiling wall 83. A lock projection 85A is provided in a central part of the lock arm 85. An operating portion 85B is provided in a rear end part of the lock arm 85. A protection wall 88 is provided to surround the operating portion 85B in a region from the ceiling wall 83 to the both side walls 86.

As shown in FIG. 10, a wire bending portion 89 is provided on the lower surface of the ceiling wall 83. The wire bending portion 89 is composed of a plurality of individual bending portions 89A arranged side by side in the width direction. The individual bending portion 89A is provided in a rear half of the lower surface of the ceiling wall 83. The lower surface of the individual bending portion 89A is formed to project downward.

The insulation coating 22 of the wire 20 in the uppermost stage is accommodated between the individual bending portion 79A of the second sub-housing 70 and the individual bending portion 89A of the lock member 80. If the wire 20 is pulled rearward, the insulation coating 22 contacts the individual bending portions 79A and 89A to generate frictional resistance, whereby the insulation coating 22 of the wire 20 is held. In this way, the core wire 21 can be prevented from being pulled rearward when the wire 20 is pulled.

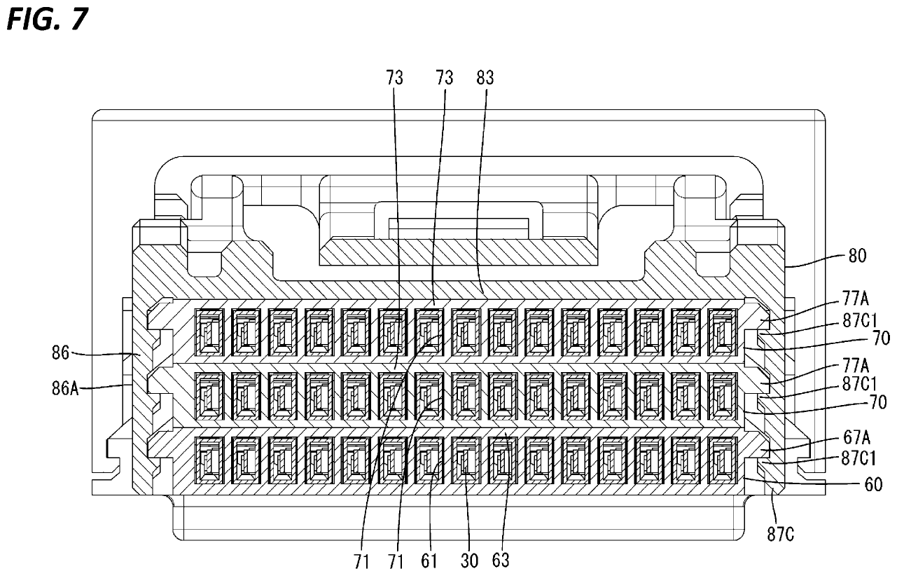

A front collective locking portion 87C, a front locking portion 87B, a rear collective locking portion 88C and a rear locking portion 88B are provided in turn from front on the side wall 86. The front edge of the front collective locking portion 87C is coupled to the front member 81, and the upper edge of the front collective locking portion 87C is coupled to the ceiling wall 83. A plurality of projections 87C1 are provided on the inner side surface of the front collective locking portion 87C. The respective projections 87C lock the respective front receiving portions 67A, 77A from below as shown in FIG. 7. In this way, front halves of the respective sub-housings 60, 70 are positioned at proper stacked positions and position shifts caused by tolerance accumulation are mitigated.

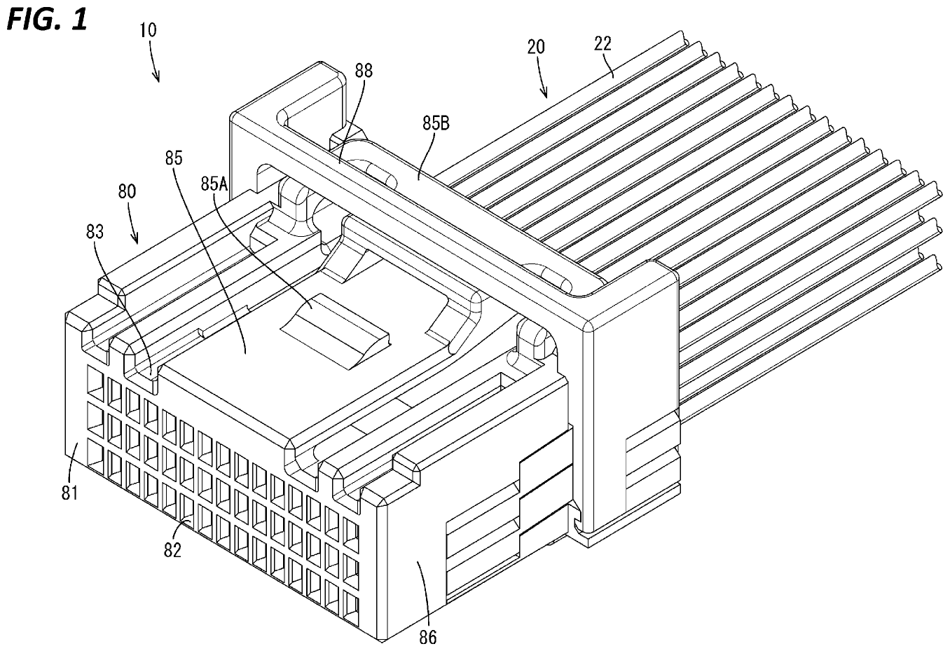

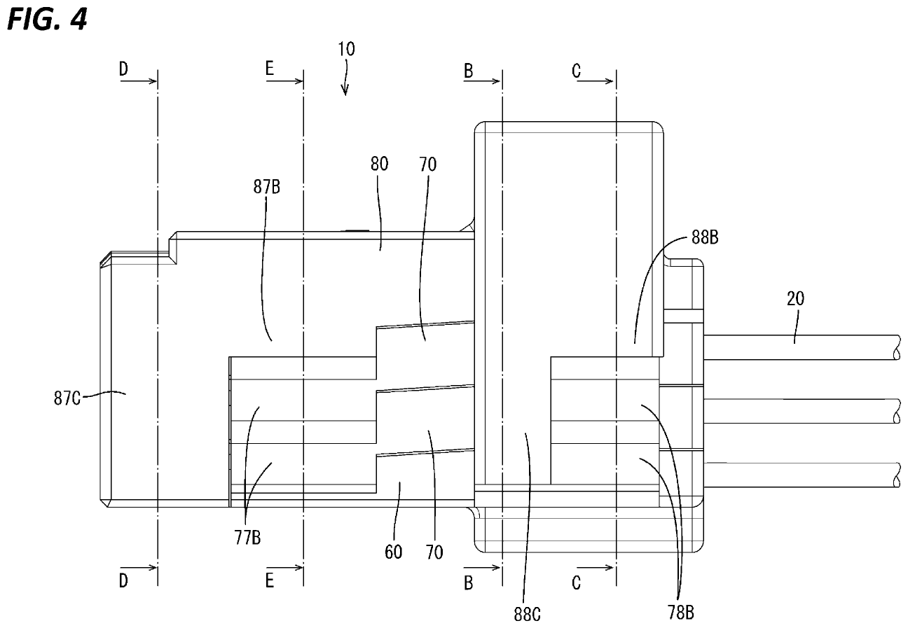

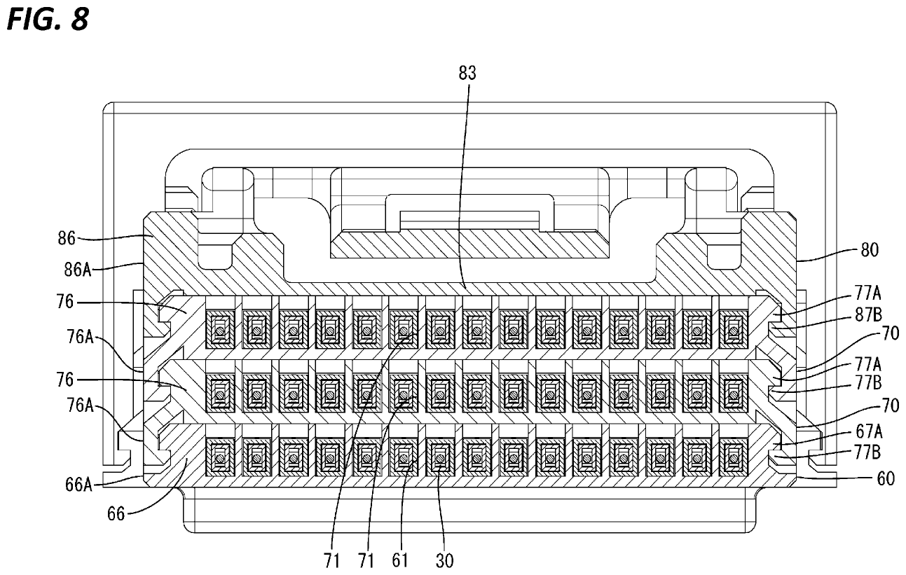

The front locking portion 87B is connected behind the front collective locking portion 87C as shown in FIGS. 1 and 4. The upper edge of the front locking portion 87B is coupled to the ceiling wall 83. As shown in FIG. 8, the front locking portions 87B of the lock member 80 lock the front receiving portions 77A of the second sub-housing 70 in the upper stage from below. In this way, a front half of the second sub-housing 70 in the upper stage and a front half of the lock member 80 stacked above the former front half are held in a properly stacked state.

If the entire connector 10 is viewed, the front halves of the respective sub-housings 60, 70 and the front half of the lock member 80 are held in a properly stacked state by the locking of the front collective locking portions 87C and the locking of the front locking portions 87B.

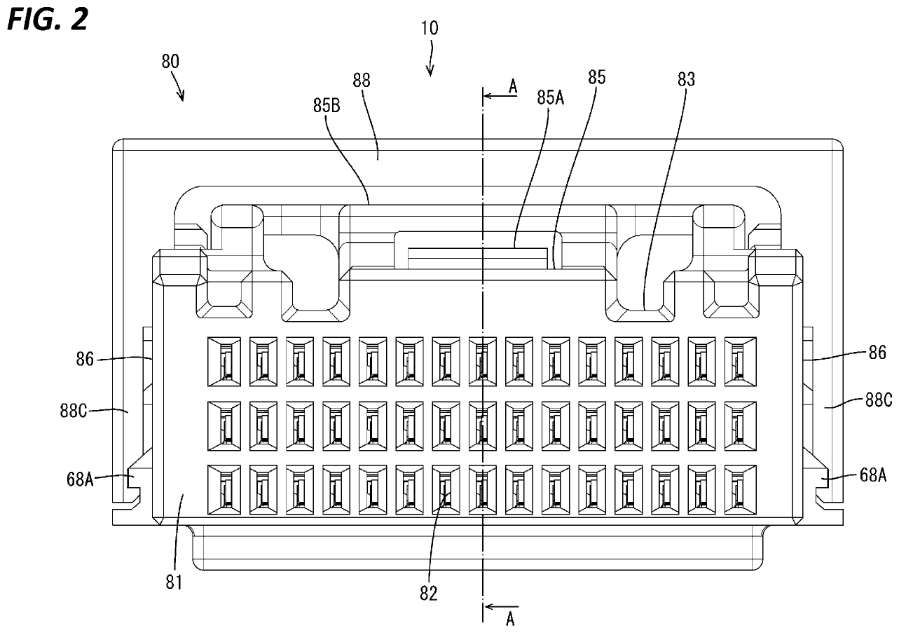

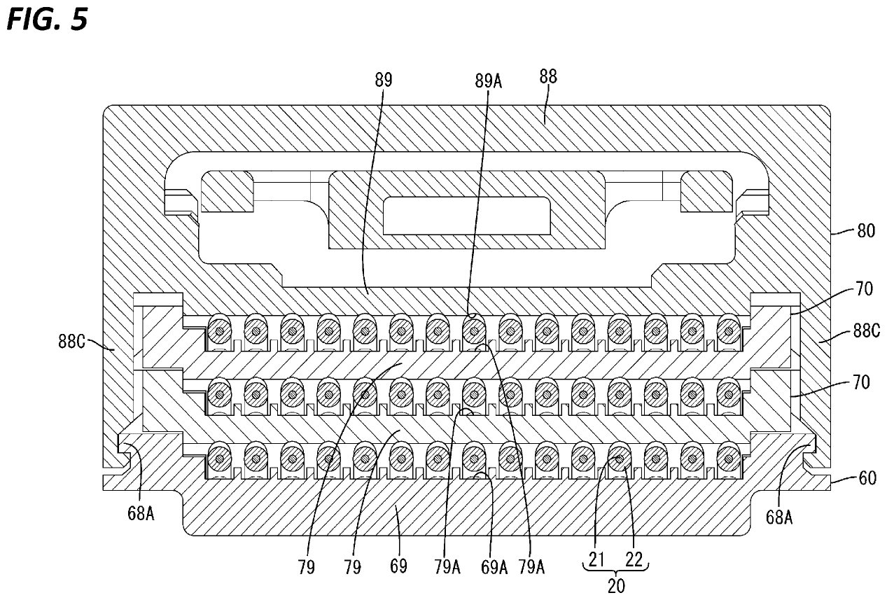

The rear collective locking portions 88C and the rear locking portions 88B are integrally provided to the protection wall 88 as shown in FIGS. 1 and 2. The upper edges of the rear collective locking portions 88C are coupled to the protection wall 88. The side surfaces of the rear collective locking portions 88C are disposed to be flush with the side surfaces of the protection wall 88. As shown in FIG. 5, the rear collective locking portions 88C lock the rear receiving portions 68A of the first sub-housing 60 from below. In this way, rear halves of the respective sub-housings 60, 70 are positioned at proper stack positions and position shifts caused by tolerance accumulation are mitigated.

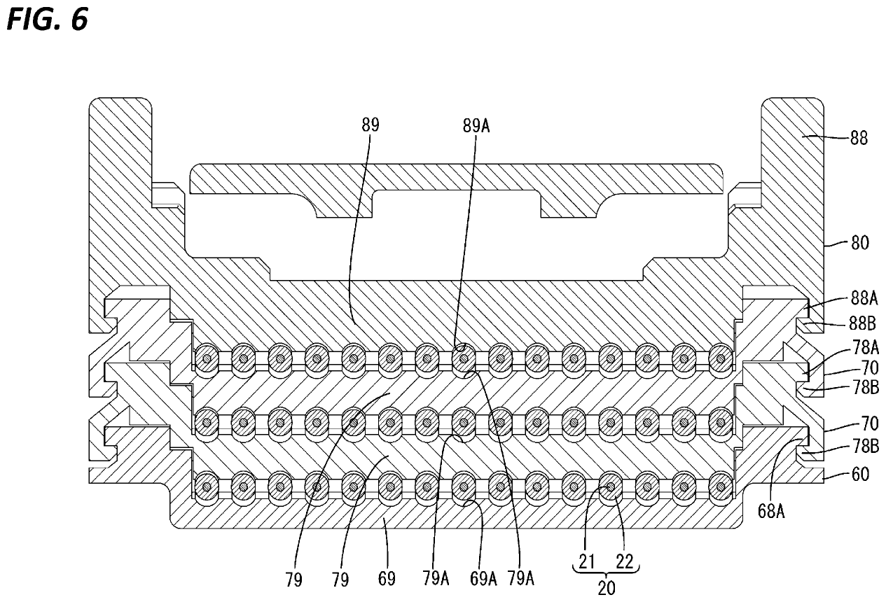

As shown in FIGS. 1 and 4, the rear locking portion 88B is connected behind the rear collective locking portion 88C. The side surface of the rear locking portion 88B is disposed to be flush with the side surface of the protection wall 88. As shown in FIG. 6, the rear locking portions 88B of the lock member 80 lock the rear receiving portions 78A of the second sub-housing 70 in the upper stage from below. In this way, the rear half of the second sub-housing 70 in the upper stage and a rear half of the lock member 80 stacked above the former rear half are held in a properly stacked state.

The rear collective locking portions 88C are arranged to face parts of the side surfaces 66A, 76A and 86A of the side walls 66, 76 and 86 corresponding to the wire bending portions 69, 79 and 89. Since the wire bending portions 69, 79 and 89 need to hold the respective sub-housings 60, 70 in the properly stacked state against reaction forces of the wires 20, these need to have a strong holding force. Accordingly, a strong holding force is obtained by using the locking of the rear collective locking portions 88C in addition to the locking of the respective rear locking portions 78B, 88B. Therefore, the separation of the respective sub-housings 60, 70 can be effectively suppressed.

If the entire connector 10 is viewed, the rear halves of the respective sub-housings 60, 70 and the rear half of the lock member 80 are held in the properly stacked state by the locking of the rear collective locking portions 88C and the locking of the rear locking portions 88B.

[Assembly Method of Connector 10]

The connector 10 is assembled by way of assembling steps 1 to 6 shown in FIGS. 12 to 17. As shown in FIG. 12, the slide portion 50 of the terminal 30 is set at the partial locking position with respect to the terminal body 40, and the terminal 30 is accommodated into the cavity 61 of the first sub-housing 60 with the locking lance 46 facing up. After all the terminals 30 are accommodated into all the cavities 61, the core wires 21 of the wire 20 are inserted into the slide portions 50 from behind. As shown in FIG. 13, the core wires 21 of all the wires 20 are accommodated into the wire connecting portions 42 of the terminal bodies 40. If all the slide portions 50 are collectively slid from the partial locking position to the full locking position using a jig, all the core wires 21 and all the terminals 30 are electrically connected and all the wires 20 are respectively pulled out rearward from all the terminals 30 as shown in FIG. 14.

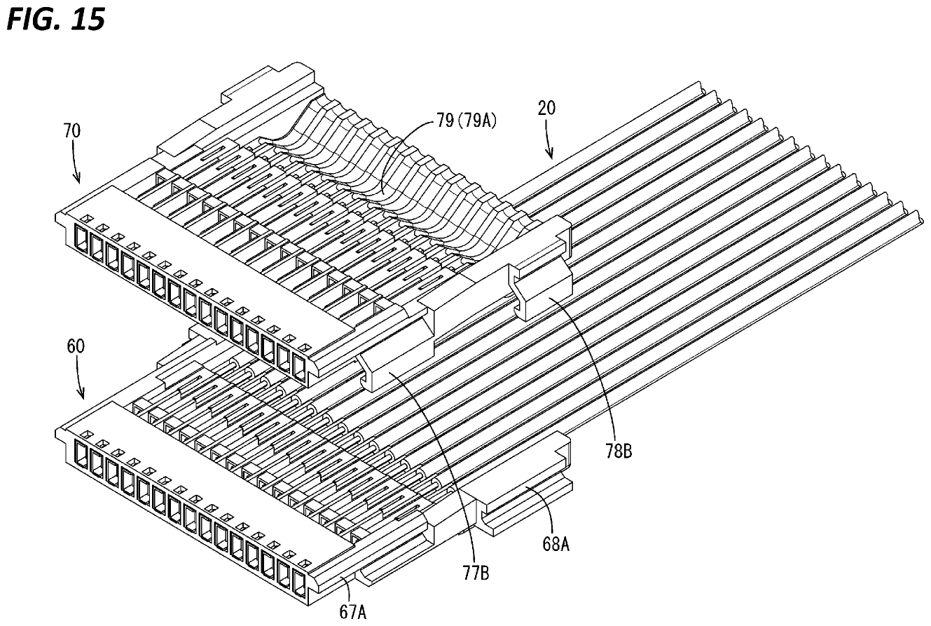

Subsequently, the terminals 30 are accommodated into the cavities 71 of the second sub-housing 70 in the lower stage. The terminals 30 are accommodated into the cavities 71 of the second sub-housing 70 in the lower stage with the locking lances 46 facing up. Therefore, after all the terminals 30 are accommodated into all the cavities 71, the second sub-housing 70 in the lower stage needs not be turned upside down and, as shown in FIG. 15, the second sub-housing 70 in the lower stage is directly assembled with the first sub-housing 60 from above.

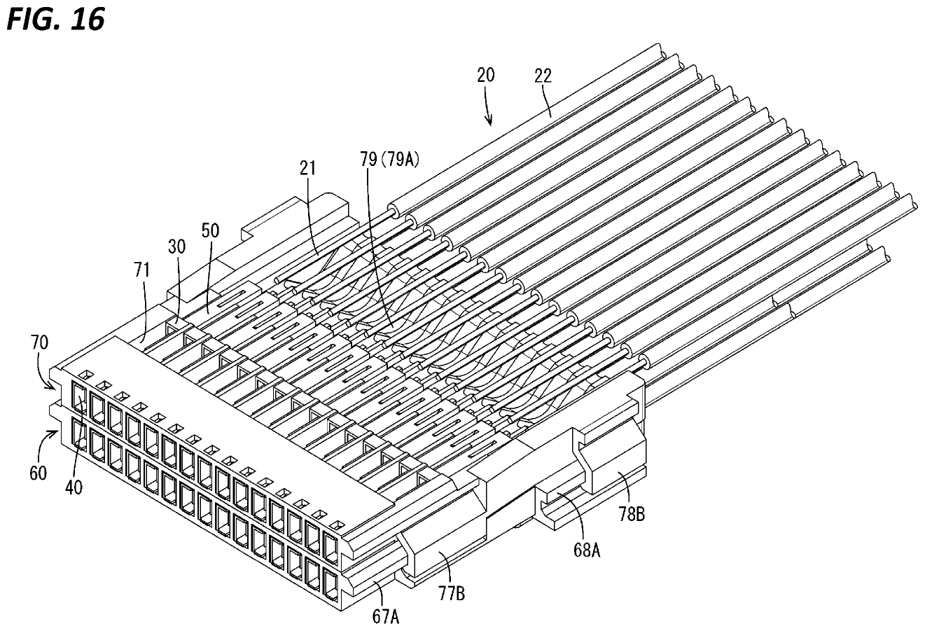

At this time, the wires 20 are bent downward by the wire bending portion 79 of the second sub-housing 70 in the lower stage. Since the respective wires 20 are bent by the respective individual bending portions 79A, there is no interaction between the wires 20. Thus, even if the number of the wires 20 increases or decreases, a holding force in each individual bending portion 79A does not change. If the respective locking portions 77B, 78B ride over and lock the respective receiving portions 67A, 68A from below while bending the wires 20 in this way, the first sub-housing 60 and the second sub-housing 70 in the lower stage are held in a stacked state as shown in FIG. 16.

Subsequently, the slide portions 50 of the terminals 30 are set at the partial locking position with respect to the terminal bodies 40, and the terminals 30 are accommodated into the cavities 71 of the second sub-housing 70 in the upper stage with the locking lances 46 facing up. After all the terminals 30 are accommodated into all the cavities 71, the second sub-housing 70 in the upper stage is directly assembled with the second sub-housing 70 in the lower stager from above without being turned upside down. If all the slide portions 50 are collectively slid from the partial locking position to the full locking position using the jig after the core wires 21 of all the wires 20 are accommodated into the wire connecting portions 42 of all the terminal bodies 40, all the core wires 21 and all the terminals 30 are electrically connected and all the wires 20 are respectively pulled out rearward from all the terminals 30.

Here, even if the number of the stages of the second sub-housings 70 increases due to the multi-polarization of the connector 10, bending is performed for each stage. Thus, an increase in force necessary to bend the wires 20 can be suppressed. In this way, the sub-housing assy 11 is configured in which the first sub-housing 60 and the second sub-housings 70 in two upper and lower stages are held in the stacked state as shown in FIG. 17. Finally, the lock member 80 is assembled with the sub-housing assy 11 from above, whereby the connector 10 is completed as shown in FIG. 1.

As described above, the connector 10 of this embodiment is provided with the plurality of terminals 30, the plurality of wires 20, the plurality of sub-housings 60, 70 and the lock member 80, the terminal 30 includes the locking lance 46, the sub-housing 60, 70 includes the cavities 61, 71 for accommodating the terminals 30 and the lance locking portions 64, 74 for retaining the terminals 30 by locking the locking lances 46 from behind, the plurality of wires 20 are respectively pulled out rearward from the plurality of terminals 30, the plurality of sub-housings 60, 70 are assembled with each other with the locking lances 46 of the terminals 30 facing in the same direction, and the plurality of sub-housings 60, 70 are held in an assembled state by the lock member 80.

Since the plurality of sub-housings 60, 70 can be assembled with each other with the locking lances 46 of the terminals 30 facing in the same direction, the sub-housings 60, 70 need not be turned upside down after the terminals 30 are accommodated into the sub-housings 60, 70 and an assembling operation of the sub-housings 60, 70 can be simplified.

Preferably, the sub-housing 60, 70 includes the wire bending portion 69, 79 for bending the wires 20 in a direction different from a pull-out direction of the wires 20 and the side surfaces 66A, 76A disposed laterally to the wire bending portion 69, 79, the lock member 80 includes the rear collective locking portions 88C for collectively holding the plurality of sub-housings 60, 70 in the assembled state, and the rear collective locking portions 88C are arranged to face the parts of the side surfaces 66A, 76A corresponding to the wire bending portions 69, 79.

Since the wires 20 bent by the wire bending portions 69, 79 try to be restored to the initial shape by reaction forces, the wires 20 act to separate the respective sub-housings 60, 70. Accordingly, the rear collective locking portions 88C are arranged to face the parts of the side surfaces 66A, 76A of the sub-housings 60, 70 corresponding to the wire bending portions 69, 79. Therefore, the separation of the respective sub-housings 60, 70 can be effectively suppressed.

The wire bending portion 69, 79, 89 preferably includes the plurality of individual bending portions 69A, 79A, 89A for individually bending and holding the plurality of wires 20.

Since the wires 20 are individually bent and held by the individual bending portions 69A, 79A, 89A, there is no interaction between the wires 20 and holding forces do not change due to an increase or decrease in the number of the wires 20.

### OTHER EMBODIMENTS

(1) Although the plurality of sub-housings 60, 70 are assembled with each other with the locking lances 46 facing up in the embodiment, the locking lances 46 may be facing down or laterally.
(2) Although the lock member 80 includes the front member 81 in the embodiment, each sub-housing 60, 70 may include a front member.
(3) Although the rear collective locking portions 88C and the rear locking portions 88B are arranged to face the parts of the side surfaces 66A, 76A corresponding to the wire bending portions 69, 79 in the embodiment, only the rear collective locking portions 88C may be provided.
(4) Although one wire 20 is bent by each of the individual bending portions 69A, 79A and 89A in the embodiment, the number of the wires 20 to be bent is not necessarily one and, for example, two wires 20 may be bent by each individual bending portion.

### LIST OF REFERENCE NUMERALS

10 connector
11 sub-housing assy
20 wire
21 core wire
22 insulation coating
30 terminal
40 terminal body
41 tube portion
42 wire connecting portion
43A upper sandwiching portion
43B lower sandwiching portion
44 contact piece
45A upper holding protrusion
45B lower holding protrusion
46 locking lance (locked portion)
50 slide portion
51A upper pressurizing portion
51B lower pressurizing portion
60 first sub-housing
61 cavity (terminal accommodating portion)
62 separation wall
63 ceiling wall
64 lance locking portion (locking portion)
65 ceiling opening
66 side wall
66A side surface
67A front receiving portion
68A rear receiving portion
69 wire bending portion
69A individual bending portion
70 second sub-housing
71 cavity (terminal accommodating portion)
72 separation wall
73 ceiling wall
74 lance locking portion (locking portion)
75 ceiling opening
76 side wall
76A side surface
77A front receiving portion
77B front locking portion
78A rear receiving portion
78B rear locking portion
79 wire bending portion
79A individual bending portion
80 lock member
81 front member
82 cavity
83 ceiling wall
85 lock arm
85A lock projection
85B operating portion
86 side wall
86A side surface
87B front locking portion
87C front collective locking portion
87C1 projection
88 protection wall
88B rear locking portion
88C rear collective locking portion
89 wire bending portion
89A individual bending portion

1. A connector, comprising:
a plurality of terminals;
a plurality of wires;
a plurality of sub-housings; and
a lock member,
the terminal including a locked portion,
the plurality of wires being respectively pulled out rearward from the plurality of terminals,
the lock member including a collective locking portion for collectively holding the plurality of sub-housings in an assembled state,
the sub-housing including a terminal accommodating portion for accommodating the terminal, a locking portion for retaining the terminal by locking the locked portion from behind, a wire bending portion for bending the wire in a direction different from a pull-out direction of the wire and a side surface disposed laterally to the wire bending portion,
the plurality of sub-housings including a lower stage side sub-housing, a middle stage side sub-housing and an upper stage side sub-housing successively stacked in a vertical direction from a lower side,
the lock member including a ceiling wall to be stacked above the upper stage side sub-housing and a pair of side walls extending downward from both side edges of the ceiling wall,
the collective locking portion and a rear locking portion being successively provided from a front side on the side wall,
the rear locking portion holding a pair of the sub-housings adjacent in a stacking direction in a properly stacked state,
the collective locking portion being arranged to face parts of the side surfaces corresponding to the wire bending portions, the collective locking portion locking a rear receiving portion provided on the lower stage side sub-housing to position the plurality of sub-housings at proper stacked positions, and
the plurality of sub-housings being assembled with each other with the locked portions of the terminals facing in the same direction, the plurality of sub-housings being held in the assembled state by the collective locking portion and the rear locking portion.

2. (canceled)

3. The connector of claim 1, wherein the wire bending portion includes a plurality of individual bending portions for individually bending and holding a plurality of the wires.
